(19) United States
(12) Patent Application Publication
(10) Pub. No.: US 2009/0245278 A1
(43) Pub. Date: Oct. 1, 2009

(54) NETWORK ADDRESS TRANSLATION BYPASSING BASED ON NETWORK LAYER PROTOCOL

(75) Inventor: Tommy Wing Chau Kee, Richmond (CA)

Correspondence Address: FIALA & WEAVER, P.L.L.C.;C/O CPA GLOBAL, P.O. BOX 52050, MINNEAPOLIS, MN, 55402, US

(73) Assignee: Broadcom Corporation, Irvine, CA (US)

(21) Appl. No.: 12/059,062

(22) Filed: Mar. 31, 2008

(51) Int. Cl. H04J 3/16

(52) U.S. Cl. 370/467

(57) ABSTRACT

A system, method and apparatus are described herein that allow a mix computers or other devices that are configured for communication in accordance with different network layer protocols, such as Internet Protocol version 4 (IPv4) and Internet Protocol version 6 (IPv6), to share a single physical connection to a WAN. To achieve this, a networking device such as a router resides between a plurality of local devices and the physical connection to the WAN and routes network layer packets between the local devices and the WAN. The networking device determines whether each local device is IPv4-capable or IPv6-capable. Based on this determination, the networking device selectively applies Network Address Translation (NAT) and optional firewall functionality to network traffic originating from or destined for the IPv4-capable devices, while bypassing such functionality for IPv6 network traffic originating from or destined for the IPv6-capable devices.

### BACKGROUND OF THE INVENTION

1. Field of the Invention

The invention generally relates to systems, methods and devices used for connecting computers and other devices to a Wide Area Network (WAN), such as the Internet, for the purposes of network communication.

2. Background

Conventional home routers are designed to connect one or more computers or other devices located in a home to a Wide Area Network (WAN), such as the Internet. By way of illustration, FIG. 1 depicts a block diagram of a network system 100 that includes a conventional home router 104. As shown in FIG. 1, conventional home router 104 operates to connect a plurality of devices 102 in a home or other location to a WAN 106, such as the Internet, for the purposes of network communication. In system 100, each of devices 102 is configured to communicate with entities on WAN 106 using the Internet Protocol version 4 (IPv4) network layer protocol. As will be appreciated by persons skilled in the art, IPv4 is the fourth iteration of the Internet Protocol (IP) and is currently the dominant network layer protocol used for Internet-based communication.

To facilitate IPv4-based communication between devices 102 and entities on WAN 106, conventional home router 104 is configured to assign a private IP address to each of devices 102. In accordance with Request for Comments (RFC) 1918, these addresses are in private network address blocks 192.168.x.x, 172.16.x.x through 172.31.x.x, and 10.x.x.x. Conventional home router 104 also has a private IP address in the same address space. However, for the purposes of communicating with entities on WAN 106, conventional home router 104 is assigned a single public IPv4 address by an Internet Service Provider (ISP) (not shown in FIG. 1).

As conventional home router 104 passes IP packets from devices 102 to WAN 106, Network Address Translation (NAT) functionality 108 within conventional home router 104 translates the source address of each IP packet from a private IP address to the public IP address assigned to conventional home router 104 and also typically re-writes the TCP (Transmission Control Protocol)/UDP (User Datagram Protocol) port numbers of each IP packet. NAT functionality 108 also tracks basic data about each active connection with devices 102, including a destination IP address and TCP/UDP port associated with each active connection. When a reply returns from WAN 106 to conventional home router 104, NAT functionality 108 uses the connection tracking data stored during the outbound phase to identify the device 102 to which the reply should be forwarded. Often, the TCP/UDP client port number is used to de-multiplex the packets.

NAT was developed, in part, to contend with the fact that there will not be enough publicly-routable IPv4 addresses to provide a distinct address to every entity capable of communicating over the Internet and also to avoid the difficulty of reserving IP addresses. In accordance with IPv4, each entity on the network is assigned a unique IP address that is expressed in dotted decimal format (for example 66.230.200.110). Each octet, or part of the address, must be a number from 0 to 255 and therefore there is a logical maximum of 4,294,967,296 addresses available for use. The decreasing availability of publicly-available IPv4 addresses has been a concern since the 1980s.

Another advantage of NAT is that it protects devices on the home network from intrusion attempts. For example, with reference to system 100 of FIG. 1, since none of devices 102 has a publicly-routable IP address, it is not possible for an intruder to attempt to communicate directly with those devices unless NAT functionality 108 is specifically configured to enable such traffic. As further shown in FIG. 1, conventional home router 104 may also include firewall functionality 110 to provide further protection against security attacks for devices 102.

The next iteration of the Internet Protocol is IPv6. The main change brought by IPv6 is a much larger address space that allows greater flexibility in assigning addresses. The extended address length eliminates the need to use NAT to avoid address exhaustion. Thus, an IPv6-capable device does not need to avail itself of NAT functionality to connect to the Internet. Instead, the IPv6-capable device may obtain an IPv6 address directly from an ISP and then use this IPv6 address for all WAN communication. Furthermore, if an IPv6-capable device has built-in firewall functionality, then such a device also need not avail itself of router-based firewall functionality. Consequently, an IPv6-capable device may be connected directly to a WAN without using a router such as conventional home router 104 shown in FIG. 1.

It is anticipated that many homes will employ a mix of IPv4-capable and IPv6-capable devices. If such homes provide only a single physical connection to a WAN, then a conventional home router with NAT functionality must be used as the WAN gateway to accommodate the IPv4-capable devices. This creates a problem, however, because such conventional home routers are not configured to support IPv6 traffic. Consequently, there would be no straightforward way to share the single physical connection to the WAN between the IPv4-capable devices, which require a conventional home router having NAT functionality, and the IPv6-capable devices, which are capable of connecting to the WAN directly.

Furthermore, it is anticipated that many IPv6-capable devices will be wireless devices. Wireless devices are typically supported in a home through the use of one or more wireless routers in conjunction with a main home router to create a wireless local area network (WLAN). The wireless router(s) establish wireless links with the wireless devices and perform important link layer services such as device authentication and encryption in order to maintain the WLAN. The main home router connects the wireless devices on the WLAN to the WAN via a single physical connection. In some implementations, a wireless router and the main home router are embodied in the same physical device. Here again, if the main home router performs NAT, then a wireless IPv6-capable device will be unable to utilize the WLAN or avail itself of the important link layer services provided by the wireless router(s) used to implement the WLAN.

Thus, what is needed is a means for connecting both IPv4-capable and IPv6-capable computers and other devices to a WAN, such as the Internet, in a scenario where only one physical connection to the WAN is available. This scenario may arise, for example, where a home or other location affords only a single physical connection to the WAN or provides only a single WLAN for connecting wireless devices to the WAN.

### BRIEF SUMMARY OF THE INVENTION

A system, method and apparatus are described herein that allow a mix computers or other devices that are configured for communication in accordance with different network layer protocols, such as Internet Protocol version 4 (IPv4) and Internet Protocol version 6 (IPv6), to share a single physical connection to a wide area network (WAN). To achieve this, a networking device such as a router resides between a plurality of local devices and the physical connection to the WAN and routes network layer packets between the local devices and the WAN. The networking device determines whether each local device is IPv4-capable or IPv6-capable. Based on this determination, the networking device selectively applies Network Address Translation (NAT) and optional firewall functionality to network traffic originating from or destined for the IPv4-capable devices, while bypassing such functionality for IPv6 network traffic originating from or destined for the IPv6-capable devices. This allows the IPv6 device to obtain IP services (e.g., obtaining an IPv6 address and IPv6-based network traffic) directly from the WAN without interference by the NAT and optional firewall functionality.

In particular, a method for routing network traffic between a plurality of local devices and a WAN is described herein. In accordance with the method, an outgoing network layer packet destined for the WAN is received from one of the plurality of local devices. A determination is made as to whether the outgoing network layer packet is associated with a local device that is configured for network communication in accordance with a first network layer protocol or a local device that is configured for network communication in accordance with a second network layer protocol. Responsive to a determination that the outgoing network layer packet is associated with a local device that is configured for network communication in accordance with the first network layer protocol, a network address translation function is performed on the outgoing network layer packet prior to transmitting the outgoing network layer packet to the WAN. Responsive to at least a determination that the outgoing network layer packet is associated with a local device that is configured for network communication in accordance with the second network layer protocol, the network address translation function is bypassed and the outgoing network layer packet is transmitted directly to the WAN.

In accordance with one implementation of the foregoing method, the first network layer protocol is IPv4 and the second network layer protocol is IPv6.

The foregoing method may further include performing a firewall function on the outgoing network layer packet prior to transmitting the outgoing network layer packet to the WAN responsive to determining that the outgoing network layer packet is associated with a local device that is configured for communication in accordance with the first network layer protocol and bypassing the firewall function and transmitting the outgoing network layer packet directly to the WAN responsive to at least determining that the outgoing network layer packet is associated with a local device that is configured for communication in accordance with the second network layer protocol.

In accordance with the foregoing method, the step of determining if the outgoing network layer packet is associated with a local device that is configured for network communication in accordance with a first network layer protocol or a local device that is configured for network communication in accordance with a second network layer protocol may include obtaining a unique identifier from a header of an Ethernet frame that carries the outgoing network layer packet and determining if the obtained unique identifier matches any one of one or more unique identifiers stored in a local memory, wherein the stored unique identifiers are associated with local devices that are configured for network communication in accordance with the second network layer protocol.

The foregoing method may also include the following steps. First, an incoming network layer packet is received from the WAN. Then, a determination is made as to whether the incoming network layer packet is associated with a local device that is configured for network communication in accordance with the first network layer protocol or a local device that is configured for network communication in accordance with the second network layer protocol. Responsive to a determination that the incoming network layer packet is associated with a local device that is configured for network communication in accordance with the first network layer protocol, a network address translation function is performed on the incoming network layer packet prior to transmitting the incoming network layer packet to one of the plurality of local devices. Responsive to at least a determination that the incoming network layer packet is associated with a local device that is configured for network communication in accordance with the second network layer protocol, the network address translation function is bypassed and the incoming network layer packet is transmitted directly to one of the plurality of local devices.

The foregoing method may also include performing a firewall function on the incoming network layer packet prior to transmitting the incoming network layer packet to one of the plurality of local devices responsive to determining that the incoming network layer packet is associated with a local device that is configured for network communication in accordance with the first network layer protocol and bypassing the firewall function and transmitting the incoming network layer packet directly to one of the plurality of local devices responsive to at least determining that the incoming network layer packet is associated with a local device that is configured for network communication in accordance with the second network layer protocol.

An apparatus is also described herein. The apparatus includes a first interface configured for communication with a WAN, a plurality of second interfaces, each of the plurality of second interfaces configured for communication with a corresponding one of a plurality of local devices, NAT logic, and first control logic coupled to the first interface, the plurality of second interfaces and the NAT logic. The first control logic is configured to receive an outgoing network layer packet from one of the plurality of local devices via a corresponding second interface and to determine if the outgoing network layer packet is associated with a local device that is configured for network communication in accordance with a first network layer protocol or a local device that is configured for network communication in accordance with a second network layer protocol. The first control logic is further configured to pass the outgoing network layer packet to the NAT logic prior to transmission of the outgoing network layer packet to the WAN via the first interface responsive to determining that the outgoing network layer packet is associated with a local device that is configured for communication in accordance with the first network layer protocol, and to bypass the NAT logic and transmit the outgoing network layer packet directly to the WAN via the first interface responsive to at least determining that the outgoing network layer packet is associated with a local device that is configured for communication in accordance with the second network layer protocol.

In one implementation of the foregoing apparatus, the first network layer protocol is Internet Protocol version 4 (IPv4) and the second network layer protocol is Internet Protocol version 6 (IPv6).

The foregoing apparatus may further comprise firewall logic. In accordance with such an embodiment, the first control logic may be further configured to pass the outgoing network layer packet to the firewall logic prior to transmission of the outgoing network layer packet to the WAN via the first interface responsive to determining that the outgoing network layer packet is associated with a local device that is configured for communication in accordance with the first network layer protocol and to bypass the firewall logic and transmit the outgoing network layer packet directly to the WAN via the first interface responsive to at least determining that the outgoing network layer packet is associated with a local device that is configured for communication in accordance with the second network layer protocol.

In one implementation of the foregoing apparatus, the first control logic is configured to obtain a unique identifier from a header of an Ethernet frame that carries the outgoing network layer packet and to determine if the obtained unique identifier matches any one of one or more unique identifiers stored in a local memory, wherein the stored unique identifiers are associated with local devices that are configured for network communication in accordance with the second network layer protocol.

A further implementation of the foregoing apparatus includes second control logic coupled to the first interface, the plurality of second interfaces and the NAT logic. The second control logic is configured to receive an incoming network layer packet from the WAN via the first interface and to determine if the incoming network layer packet is associated with a local device that is configured for network communication in accordance with the first network layer protocol or a local device that is configured for network communication in accordance with the second network layer protocol. The second control logic is further configured to pass the incoming network layer packet to the NAT logic prior to transmission to one of the plurality of local devices via a corresponding second interface responsive to determining that the incoming network layer packet is associated with a local device that is configured for network communication in accordance with the first network layer protocol and to bypass the NAT logic and transmit the incoming network layer packet directly to one of the plurality of local devices via a corresponding second interface responsive to at least determining that the incoming network layer packet is associated with a local device that is configured for network communication in accordance with the second network layer protocol.

In such an embodiment, the apparatus may also include firewall logic and the second control logic may be further configured to pass the incoming network layer packet to the firewall logic prior to transmission to one of the plurality of local devices via a corresponding second interface responsive to determining that the incoming network layer packet is associated with a local device that is configured for network communication in accordance with the first network layer protocol and to bypass the firewall logic and to transmit the incoming network layer packet directly to one of the plurality of local devices via a corresponding second interface responsive to at least determining that the incoming network layer packet is associated with a local device that is configured for network communication in accordance with the second network layer protocol.

A computer program product is also described herein. The computer program product comprises a computer-readable medium having computer program logic recorded thereon for enabling a processing unit to route network traffic between a plurality of local devices and a WAN. The computer program logic includes first means, second means, third means and fourth means. The first means are for enabling the processing unit to receive an outgoing network layer packet destined for the WAN from one of the plurality of local devices. The second means are for enabling the processing unit to determine if the outgoing network layer packet is associated with a local device that is configured for network communication in accordance with a first network layer protocol or a local device that is configured for network communication in accordance with a second network layer protocol. The third means are for enabling the processing unit to perform a network address translation function on the outgoing network layer packet prior to transmitting the outgoing network layer packet to the WAN responsive to a determination that the outgoing network layer packet is associated with a local device that is configured for communication in accordance with the first network layer protocol. The fourth means are for enabling the processing unit to bypass the network address translation function and transmit the outgoing network layer packet directly to the WAN responsive to at least a determination that the outgoing network layer packet is associated with a local device that is configured for communication in accordance with the second network layer protocol.

In accordance with one implementation of the foregoing computer program product, the first network layer protocol is IPv4 and the second network layer protocol is IPv6.

In accordance with the foregoing computer program product, the computer program logic may further include means for enabling the processing unit to perform a firewall function on the outgoing network layer packet prior to transmitting the outgoing network layer packet to the WAN responsive to a determination that the outgoing network layer packet is associated with a local device that is configured for communication in accordance with the first network layer protocol and means for enabling the processing unit to bypass the firewall function and transmit the outgoing network layer packet directly to the WAN responsive to at least a determination that the outgoing network layer packet is associated with a local device that is configured for communication in accordance with the second network layer protocol.

In one implementation of the foregoing computer program product, the second means comprises means for enabling the processing unit to obtain a unique identifier from a header of an Ethernet frame that carries the outgoing network layer packet and means for enabling the processing unit to determine if the obtained unique identifier matches any one of one or more unique identifiers stored in local memory, wherein the stored unique identifiers are associated with local devices that are configured for network communication in accordance with the second network layer protocol.

In accordance with a further implementation of the foregoing computer program product, the computer program logic further includes fifth means, sixth means, seventh means and eighth means. The fifth means are for enabling the processing unit to receive an incoming network layer packet from the WAN. The sixth means are for enabling the processing unit to determine if the incoming network layer packet is associated with a local device that is configured for network communication in accordance with the first network layer protocol or a local device that is configured for network communication in accordance with the second network layer protocol. The seventh means are for enabling the processing unit to perform a network address translation function on the incoming network layer packet prior to transmitting the incoming network layer packet to one of the plurality of local devices responsive to a determination that that the incoming network layer packet is associated with a local device that is configured for network communication in accordance with the first network layer protocol. The eighth means for enabling the processing unit to bypass the network address translation function and transmit the incoming network layer packet directly to one of the plurality of local devices responsive to at least a determination that the incoming network layer packet is associated with a local device that is configured for network communication in accordance with the second network layer protocol.

In accordance with the foregoing computer program product, the computer program logic may further include means for enabling the processing unit to perform a firewall function on the incoming network layer packet prior to transmitting the incoming network layer packet to one of the plurality of local devices responsive to a determination that the incoming network layer packet is associated with a local device that is configured for network communication in accordance with the first network layer protocol and means for enabling the processing unit to bypass the firewall function and transmit the incoming network layer packet directly to one of the plurality of local devices responsive to at least a determination that the incoming network layer packet is associated with a local device that is configured for network communication in accordance with the second network layer protocol.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a network system in which a conventional home router is used to connect a plurality of Internet Protocol version 4 (IPv4) capable devices to a wide area network (WAN).

FIG. 2 is a block diagram of a network system in accordance with an embodiment of the present invention in which a networking device is used to connect a mix of IPv4-capable and Internet Protocol version 6 (IPv6) capable devices to a WAN.

FIG. 3 is a block diagram that depicts networking device of FIG. 2 in more detail in accordance with one implementation of the present invention.

FIG. 4 depicts a flowchart of a method by which a networking device routes network traffic from a plurality of local devices to a WAN in accordance with an embodiment of the present invention.

FIG. 5 depicts a flowchart of a method by which a networking device routes network traffic from a WAN to one of a plurality of local devices in accordance with an embodiment of the present invention.

FIG. 6 is a block diagram demonstrating a manner in which a local IPv6-capable device may be recognized by a networking device in accordance with an embodiment of the present invention.

FIG. 7 is a block diagram of local area network (LAN) interface control logic in a networking device in accordance with an embodiment of the present invention that includes IPv6-capable device recognition logic.

FIG. 8 is a block diagram of a network system in accordance with an embodiment of the present invention in which a wireless networking device is used to connect a mix of IPv4-capable and IPv6-capable devices to a WAN.

FIG. 9 is a block diagram that depicts wireless networking device of FIG. 8 in more detail in accordance with one implementation of the present invention.

FIG. 10 is a block diagram of a networking device in accordance with an embodiment of the present invention in which several elements are implemented in software configured for execution by a processing unit.

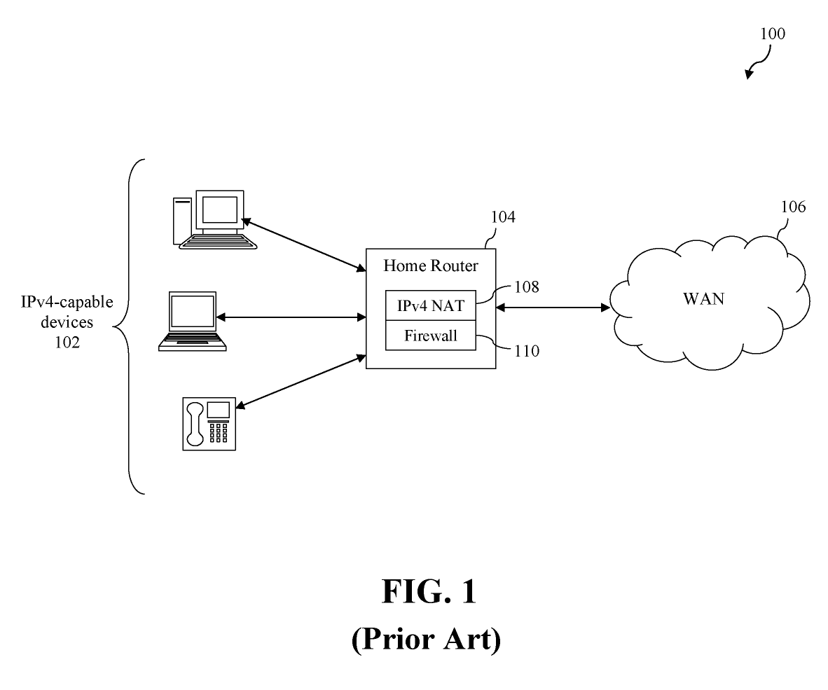

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The present specification discloses one or more embodiments of a networking device that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the statement that a device or element is “configured to” perform a function or is “adapted to perform” a function means that the device or element has been designed to perform that function or to be capable of performing that function. The use of the phrases “configured to” and “adapted to” do not necessarily mean that an end user of a device or element configured or adapted the device or element to perform the relevant function.

B. Example Network System in Accordance with an Embodiment of the Present Invention

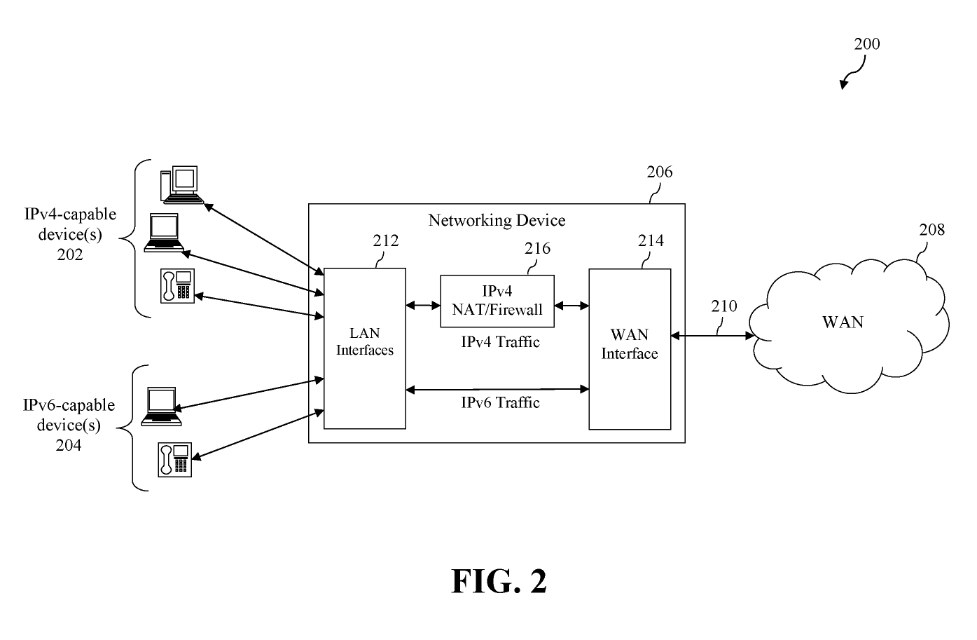

FIG. 2 is a block diagram of network system 200 in accordance with an embodiment of the present invention. As shown in FIG. 2, network system 200 includes a networking device 206 that is configured to connect a plurality of local devices to a Wide Area Network (WAN) 208, such as the Internet, for the purposes of network communication. In particular, networking device 206 is configured to route network layer packets between the local devices and WAN 208. To this end, networking device 206 includes a plurality of local area network (LAN) interfaces 212 for connecting to and communicating with the corresponding plurality of local devices and a WAN interface 214 for connecting to and communicating over WAN 208.

As further shown in FIG. 2, the plurality of local devices include one or more devices 202 capable of communicating with entities on WAN 208 using the Internet Protocol version 4 (IPv4) network layer protocol and one or more devices 204 capable of communicating with entities on WAN 208 using the Internet Protocol version 6 (IPv6) network layer protocol. As will be appreciated by persons skilled in the relevant art(s), devices 204 may also be capable of communicating with entities on WAN 208 using the IPv4 network layer protocol (i.e., devices 204 may support both IPv4-based and IPv6-based communication). However, for the sake of brevity, the former device(s) will be referred to herein as IPv4-capable device(s) 202 and the latter device(s) will be referred to herein as IPv6-capable device(s) 204.

Networking device 206 is configured to permit IPv4-capable device(s) 202 and IPv6-capable device(s) 204 to share a single physical connection 210 to WAN 208. Networking device 206 is capable of doing this despite the fact that IPv4-capable device(s) 202 require Network Address Translation (NAT) and optional firewall services as described in the Background section above, while IPv6-capable device(s) 204 may not. To achieve this, control logic within networking device 206 (not shown in FIG. 2) determines whether each local device is IPv4-capable or IPv6-capable. Based on this determination, the control logic selectively applies Network Address Translation (NAT) and optional firewall functionality to network traffic originating from or destined for the IPv4-capable devices, while bypassing such functionality for IPv6 network traffic originating from or destined for the IPv6-capable devices. This is reflected in FIG. 2, which shows that IPv4 traffic passing between LAN interfaces 212 and WAN interface 214 of networking device 206 is processed by IPv4 NAT/firewall logic 216, while IPv6 traffic passing between LAN interfaces 212 and WAN interface 214 of networking device 206 bypasses such logic. This allows IPv6-capable device(s) 204 to obtain IP services (e.g., obtaining an IPv6 address and IPv6-based network traffic) directly from WAN 208 without interference by NAT and optional firewall logic 216.

IPv4-capable device(s) 202 and IPv6-capable device(s) 204 may each include any type of system or device that is capable of being configured for network communication in accordance with either or both of the IPv4 or IPv6 network layer protocols. As will be appreciated by persons skilled in the relevant art(s), such devices may include, but are not limited to, desktop computers, laptop computers, handheld computers, Voice over Internet Protocol (VoIP) telephones, mobile telephones, personal digital assistants (PDAs), wireless access points, routers, bridges, or the like. Depending on the implementation, routing device 206 may comprise a home or small office router or any other device that incorporates the functions of a home or small office router.

C. Example Networking Device in Accordance with an Embodiment of the Present Invention

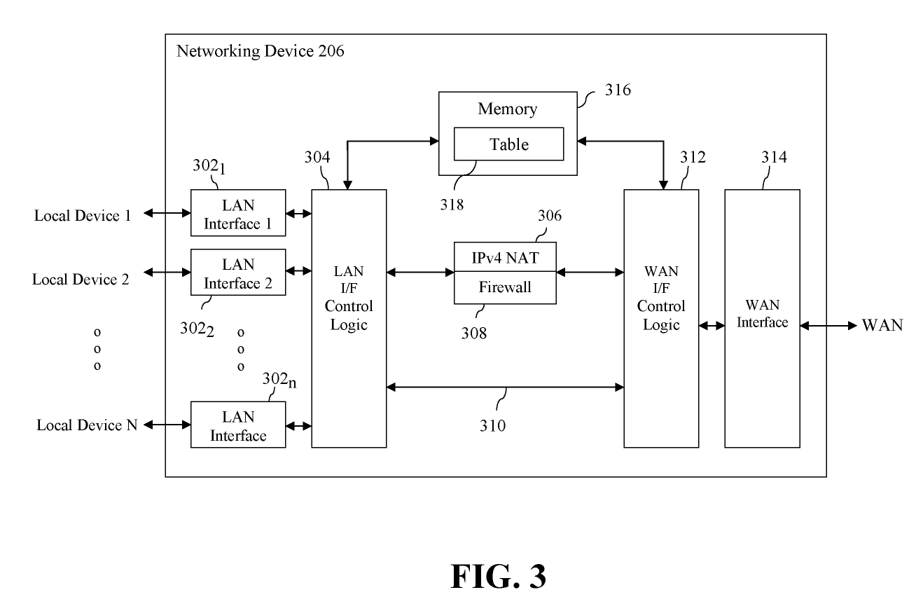

FIG. 3 is a block diagram that depicts networking device 206 of FIG. 2 in more detail. As shown in FIG. 3, networking device 206 includes a plurality of LAN interfaces 302₁, 302₂, . . . 302ₙ (denoted “LAN Interface 1,” “LAN Interface 2,” . . . “LAN Interface N”) each of which is configured for connection to and communication with a corresponding local device (denoted “Local Device 1,” “Local Device 2,” . . . “Local Device N”). In one embodiment, each of LAN interfaces 302₁-302ₙ is configured in a like manner to accommodate a wired connection to a corresponding local device. For example, in one embodiment, each of LAN interfaces 302₁-302ₙ comprises a 10/100 Ethernet port.

As also shown in FIG. 3, networking device 206 also includes a WAN interface 314 that is configured for connection to and communication with a WAN, such as the Internet. Depending on the type of physical connection used for communication the WAN, WAN interface 314 may comprise, for example, an Ethernet port, a cable modem or a DSL modem. These examples are not intended to be limiting, however, and other WAN interface types may be used.

Networking device 206 further includes LAN interface control logic 304. LAN interface control logic 304 is configured to route network layer packets received from local devices connected to LAN interfaces 302₁-302ₙ to WAN interface 314 for subsequent delivery to entities on the WAN. In performing this function, LAN interface control logic 304 is configured to first determine whether a network layer packet has been generated by an IPv4-capable device or an IPv6-capable device. If the network layer packet has been generated by an IPv4-capable device, then LAN interface control logic 304 passes the network layer packet to IPv4 NAT logic 306 and firewall logic 308 so that NAT and firewall functions may be respectively performed on the packet prior to delivery to WAN interface 314. However, if the network layer packet has been generated by an IPv6-capable device and the network layer packet is formatted in accordance with IPv6, then LAN interface control logic 304 passes the network layer packet directly to WAN interface 314 via bypass path 310.

To determine whether a network layer packet has been generated by an IPv4-capable device or an IPv6-capable device, LAN interface control logic 304 is configured to access a table 318 that is stored in a local memory 316 within networking device 206. In one embodiment, table 318 stores a list of unique identifiers (IDs) of all local IPv6-capable devices currently connected to network device 206. These unique IDs may be, for example, Ethernet addresses associated with each of the local IPv6-capable devices. In accordance with such an embodiment, LAN interface control logic 304 is configured to obtain a unique ID from the header of an Ethernet frame that carries a network layer packet received from a local device and then determines if the obtained unique ID matches any of the unique IDs stored in table 318. If a match is found, then the network layer packet is deemed to have come from an IPv6-capable device. However, if no match is found, then the network layer packet is deemed to have come from an IPv4-capable device. The manner in which unique IDs associated with local IPv6-capable devices are initially entered into table 318 will be described elsewhere herein.

Networking device 206 further includes WAN interface control logic 312. WAN interface control logic 312 is configured to route network layer packets received from the WAN to LAN interfaces 302₁-302ₙ for subsequent delivery to the local devices. In performing this function, WAN interface control logic 312 is configured to first determine whether a network layer packet is destined for an IPv4-capable device or an IPv6-capable device. If the network layer packet is destined for an IPv4-capable device, then WAN interface control logic 312 passes the network layer packet to IPv4 NAT logic 306 and firewall logic 308 so that NAT and firewall functions may be respectively performed on the packet prior to delivery to the appropriate one of LAN interfaces 302₁-302ₙ. However, if the network layer packet is destined for an IPv6-capable device and the network layer packet is formatted in accordance with IPv6, then WAN interface control logic 312 passes the network layer packet directly to the appropriate one of LAN interfaces 302₁-302ₙ via bypass path 310.

To determine whether a network layer packet is destined for an IPv4-capable device or an IPv6-capable device, WAN interface control logic 312 is configured to access table 318 stored in memory 316 in a like manner to that described above in reference to the operation of LAN interface control logic 304. In particular, WAN interface control logic 312 is configured to obtain a unique ID from the header of an Ethernet frame that carries a network layer packet received from the WAN and then determines if the obtained unique ID matches any of the unique IDs stored in table 318. If a match is found, then the network layer packet is deemed to be destined for an IPv6-capable device. However, if no match is found, then the network layer packet is deemed to be destined for an IPv4-capable device.

D. Example Methods for Routing of Network Traffic in Accordance with Embodiments of the Present Invention

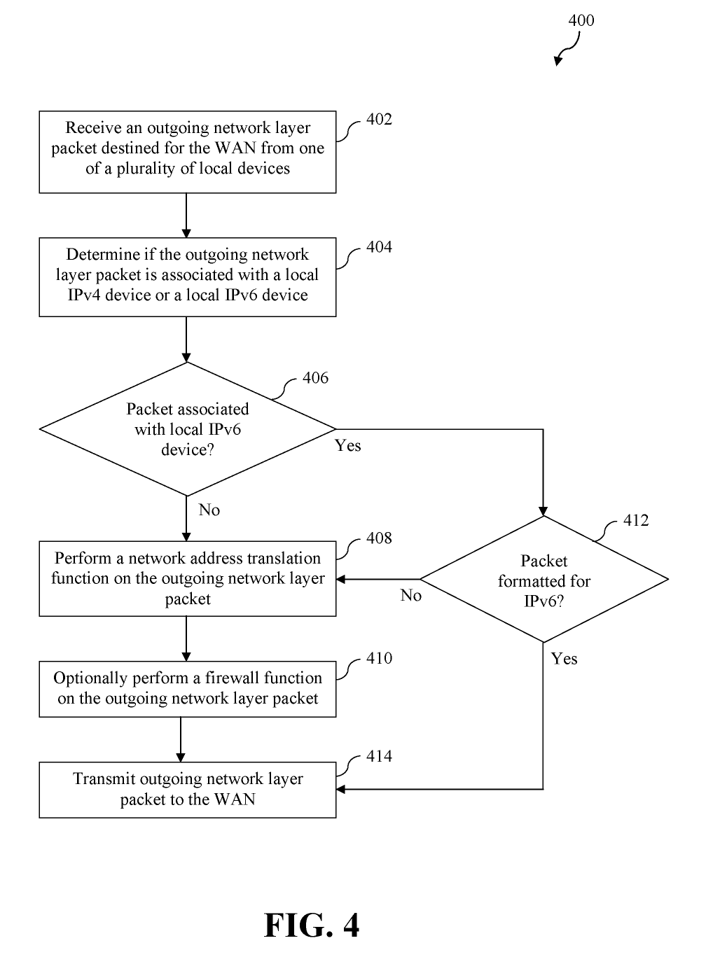

The manner by which networking device 206 routes network traffic from a plurality of local devices to a WAN will now be described in reference to flowchart 400 of FIG. 4. Although the method of flowchart 400 is described herein in reference to components of networking device 206, persons skilled in the relevant art(s) will appreciate that the method is not limited to that implementation.

As shown in FIG. 4, the method of flowchart 400 begins at step 402, in which LAN interface control logic 304 receives an outgoing network layer packet destined for the WAN from one of a plurality of local devices via a respective one of LAN interfaces 302₁-302ₙ.

At step 404, LAN interface control logic 304 determines if the outgoing network layer packet is associated with a local IPv4-capable device or a local IPv6-capable device. As noted above, this step may include obtaining a unique ID from a header of an Ethernet frame that carries the outgoing network layer packet and then determining if the obtained unique ID matches any one of one or more unique IDs stored in table 318 in local memory 316. If a match is found, then the outgoing network layer packet is determined to be associated with a local IPv6-capable device. However, if no match is found, then the outgoing network layer packet is determined to be associated with a local IPv4-capable device.

As shown at decision step 406, if LAN interface control logic 304 determines that the outgoing network layer packet is associated with a local IPv6-capable device, then processing proceeds to decision step 412, in which LAN interface control logic 304 determines whether the outgoing network layer packet is formatted in accordance with IPv6. LAN interface control logic 304 may make this determination, for example, by examining a version field in the IP header of the outgoing network layer packet. If LAN interface control logic 304 determines that the outgoing network layer packet is formatted in accordance with IPv6, then LAN interface control logic 304 bypasses IPv4 NAT logic 306 and firewall logic 308 and transmits the outgoing network layer packet directly to the WAN via WAN interface 314 as shown at step 412.

However, if LAN interface control logic 304 determines during decision step 406 that the outgoing network layer packet is associated with a local IPv4-capable device or determines during decision step 412 that the outgoing network layer packet is not formatted in accordance with IPv6, then LAN interface control logic 304 passes the outgoing network layer packet to IPv4 NAT logic 306 which performs a NAT function on the outgoing network layer packet as shown at step 408. Additionally, if LAN interface control logic 304 determines during decision step 406 that the outgoing network layer is associated with a local IPv4-capable device or determines during decision step 412 that the outgoing network layer packet is not formatted in accordance with IPv6, it may optionally pass the outgoing network layer packet to firewall logic 308 which performs a firewall function on the outgoing network layer packet as shown at step 410. After steps 408 and 410, the outgoing network layer packet is transmitted to the WAN via WAN interface 314 as shown at step 414.

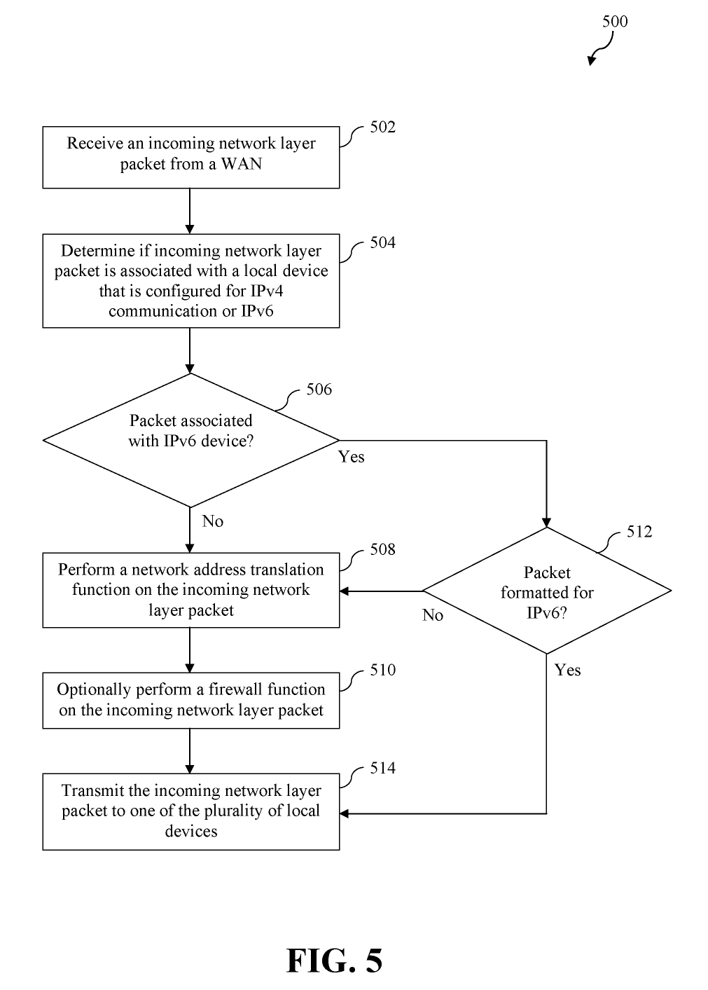

The manner by which networking device 206 routes network traffic from a WAN to one of a plurality of local devices will now be described in reference to flowchart 500 of FIG. 5. Although the method of flowchart 500 is described herein in reference to components of networking device 206, persons skilled in the relevant art(s) will appreciate that the method is not limited to that implementation.

As shown in FIG. 5, the method of flowchart 500 begins at step 502, in which WAN interface control logic 312 receives an incoming network layer packet from the WAN via WAN interface 314.

At step 504, WAN interface control logic 312 determines if the incoming network layer packet is associated with a local IPv4-capable device or a local IPv6-capable device. As noted above, this step may include obtaining a unique ID from a header of an Ethernet frame that carries the incoming network layer packet and then determining if the obtained unique ID matches any one of one or more unique IDs stored in table 318 in local memory 316. If a match is found, then the incoming network layer packet is determined to be associated with a local IPv6-capable device. However, if no match is found, then the incoming network layer packet is determined to be associated with a local IPv4-capable device.

As shown at decision step 506, if WAN interface control logic 312 determines that the incoming network layer packet is associated with a local IPv6-capable device, then processing proceeds to decision step 512, in which WAN interface control logic 312 determines whether the incoming network layer packet is formatted in accordance with IPv6. LAN interface control logic 312 may make this determination, for example, by examining a version field in the IP header of the incoming network layer packet. If WAN interface control logic 312 determines that the incoming network layer packet is formatted in accordance with IPv6, then WAN interface control logic 312 bypasses IPv4 NAT logic 306 and firewall logic 308 and transmits the incoming network layer packet directly to one of the plurality of local devices via an appropriate one of LAN interfaces 302₁-302ₙ as shown at step 512.

However, if WAN interface control logic 312 determines during decision step 506 that the incoming network layer packet is associated with a local IPv4-capable device or determines during decision step 512 that the incoming network layer packet is not formatted in accordance with IPv6, then WAN interface control logic 312 passes the incoming network layer packet to IPv4 NAT logic 306 which performs a NAT function on the incoming network layer packet as shown at step 508. Additionally, if WAN interface control logic 312 determines during decision step 506 that the incoming network layer packet is associated with a local IPv4-capable device or determines during decision step 512 that the incoming network layer packet is not formatted in accordance with IPv6, it may optionally pass the incoming network layer packet to firewall logic 308 which performs a firewall function on the incoming network layer packet as shown at step 510. After steps 510 and 512, the incoming network layer packet is transmitted to one of the plurality of local devices via an appropriate one of LAN interfaces 302₁-302ₙ as shown at step 512.

E. Example Methods for IPv6-Capable Device Recognition in Accordance with Embodiments of the Present Invention

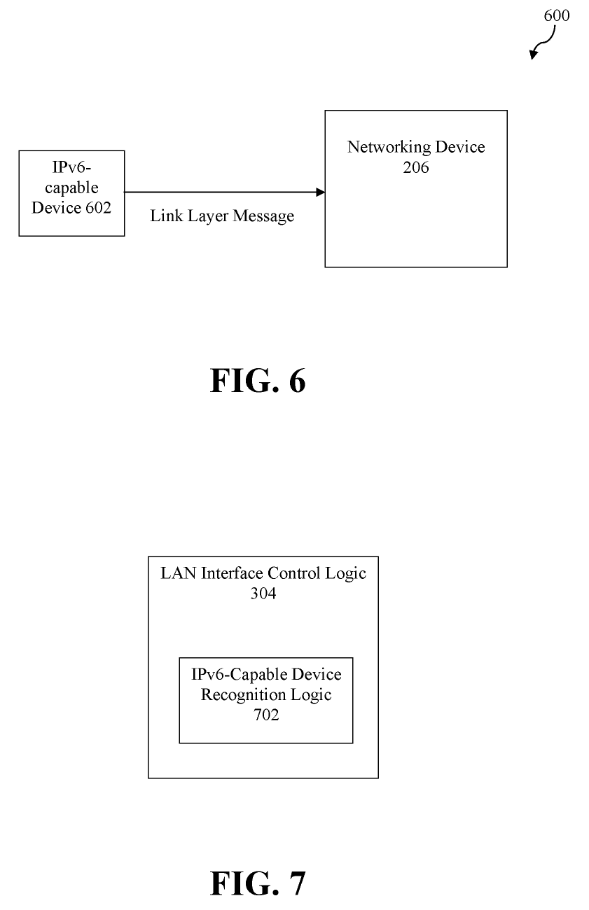

As described above, networking device 206 is configured to store unique IDs associated with local IPv6-capable devices in a table 318 in local memory 316. To perform this function, networking device 206 is configured to recognize local IPv6-capable devices that are connected to any of LAN interfaces 302₁-302ₙ. In accordance with one embodiment of the present invention, the recognition of local IPv6-capable devices is achieved through the transmission of a link layer message from a local device to networking device 206, wherein the message includes a unique ID of the local device (such as an Ethernet address) and indicates that the local device is capable of performing network communication in accordance with IPv6. Such an approach is depicted in block diagram 600 of FIG. 6, which shows a local IPv6-capable device 602 sending a link layer message to networking device 206. Responsive to the receipt of such a link layer message, networking device 206 stores a unique identifier associated with local IPv6-capable device 602 in table 318.

As shown in FIG. 7, in accordance with an alternate embodiment of the present invention, LAN interface control logic 304 includes IPv6-capable device recognition logic 702 that is configured to automatically analyze one or more network layer packets received from a local device connected to networking device 206 to determine if the local device is an IPv6-capable device. For example, the content and/or format of the network layer packets may be analyzed to determine if the packets are consistent with IPv6, and the determination may be made based on such an analysis. In one embodiment, a version field in the IP header is analyzed to determine if the packets are IPv6 packets. If a local device is determined to be an IPv6-capable device based on this analysis, a unique ID associated with the device is stored in table 318. For security reasons, this automatic detection feature may be implemented such that it can be enabled/disabled by an end user as a matter of usage policy.

In a still further embodiment, networking device 206 is configured to receive input from an end user that explicitly identifies local IPv6-capable devices that are connected to any of LAN interfaces 302₁-302ₙ. For example, such input may be provided by an end user via a computing device that is communicatively connected to networking device 206. Responsive to the receipt of such input, networking device 206 stores a unique identifier associated with each identified local IPv6-capable device 602 in table 318.

However, these examples are not intended to be limiting and networking device 206 may use other methods for recognizing local IPv6-capable devices and storing unique IDs associated with those devices in table 318.

F. Example Wireless Router Implementation in Accordance with an Embodiment of the Present Invention

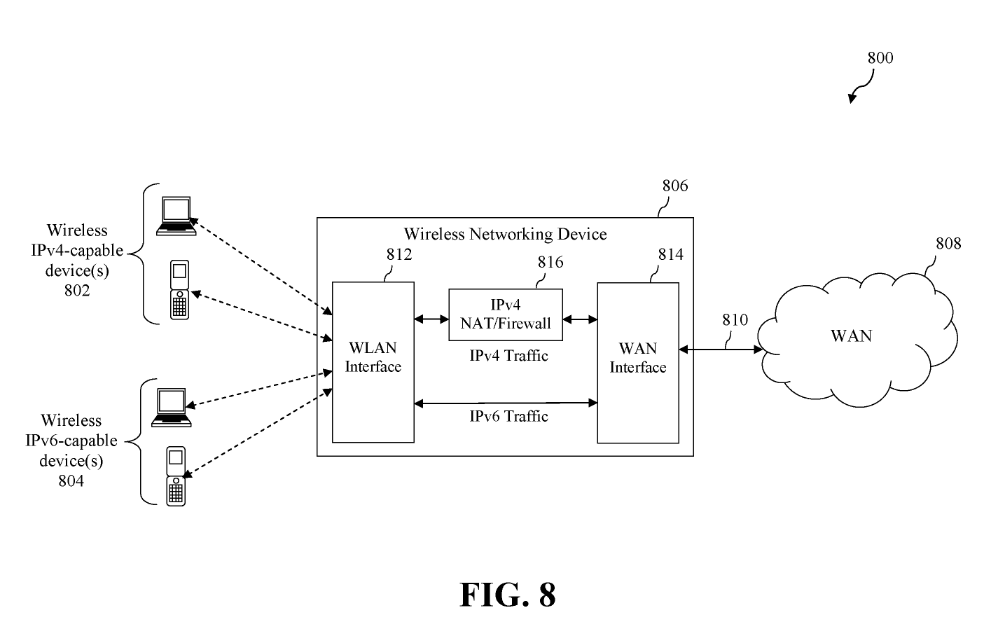

FIG. 8 is a block diagram of a network system 800 in accordance with an alternate embodiment of the present invention. As shown in FIG. 8, network system 800 includes a wireless networking device 806 that is configured to connect a plurality of wireless local devices to a WAN 808, such as the Internet, for the purposes of network communication. In particular, wireless networking device 806 is configured to route network layer packets between the wireless local devices and WAN 808. To this end, wireless networking device 806 includes a wireless LAN (WLAN) interface 812 for wirelessly connecting to and communicating with the corresponding plurality of wireless local devices and a WAN interface 814 for connecting to and communicating over WAN 808.

As further shown in FIG. 8, the plurality of wireless local devices include one or more devices 802 capable of communicating with entities on WAN 808 using the IPv4 network layer protocol and one or more devices 804 capable of communicating with entities on WAN 808 using the IPv6 network layer protocol. As will be appreciated by persons skilled in the relevant art(s), devices 804 may also be capable of communicating with entities on WAN 808 using the IPv4 network layer protocol (i.e., devices 804 may support both IPv4-based and IPv6-based communication). However, for the sake of brevity, the former device(s) will be referred to herein as wireless IPv4-capable device(s) 802 and the latter device(s) will be referred to herein as wireless IPv6-capable device(s) 804.

Wireless networking device 806 is configured to permit wireless IPv4-capable device(s) 802 and wireless IPv6-capable device(s) 804 to share a single physical connection 810 to WAN 808. To achieve this, control logic within wireless networking device 806 (not shown in FIG. 8) determines whether each wireless local device is IPv4-capable or IPv6-capable. Based on this determination, the control logic selectively applies NAT and optional firewall functionality to network traffic originating from or destined for the wireless IPv4-capable devices, while bypassing such functionality for network traffic originating from or destined for the wireless IPv6-capable devices. This is reflected in FIG. 8, which shows that IPv4 traffic passing between WLAN interface 812 and WAN interface 814 of networking device 806 is processed by IPv4 NAT/firewall logic 816, while IPv6 traffic passing between WLAN interface 812 and WAN interface 814 of networking device 806 bypasses such logic. This allows wireless IPv6-capable device(s) 804 to obtain IP services (e.g., obtaining an IPv6 address and IPv6-based network traffic) directly from WAN 808 without interference by NAT and optional firewall logic 816.

Wireless IPv4-capable device(s) 802 and wireless IPv6-capable device(s) 804 may each include any type of system or device that is capable of being configured for network communication in accordance with either or both of the IPv4 or IPv6 network layer protocols and is also capable of wireless communication with wireless networking device 806. For example, such devices may include, but are not limited to, any system or device that is configured for wireless communication in accordance with any one of the well-known IEEE 802.11 protocols.

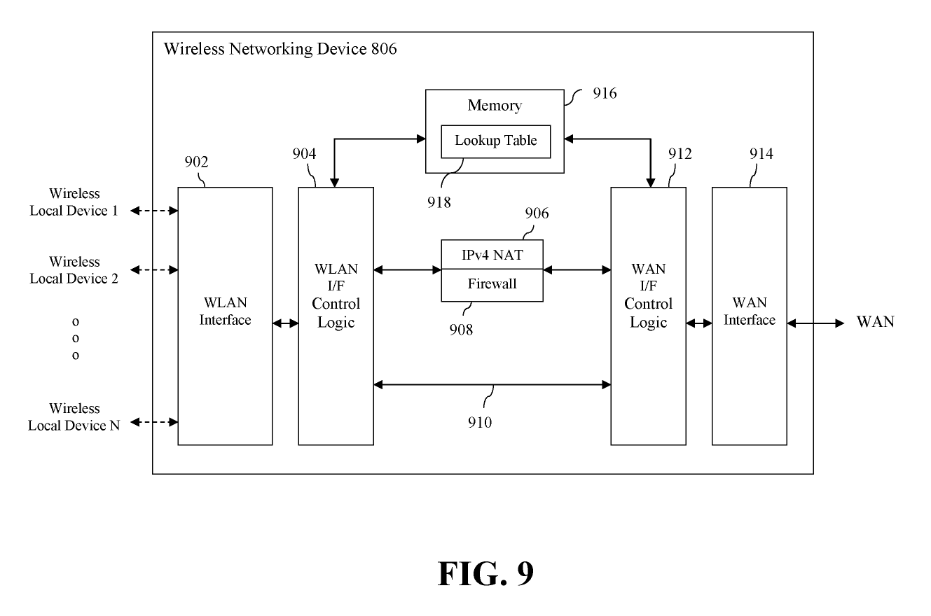

FIG. 9 is a block diagram that depicts wireless networking device 806 of FIG. 8 in more detail. As shown in FIG. 9, wireless networking device 806 includes a WLAN interface 902 that is configured for wireless connection to and communication with a plurality of wireless local devices (denoted “Wireless Local Device 1,” “Wireless Local Device 2,” . . . “Wireless Local Device N”). In one embodiment, WLAN interface is configured to communicate with the wireless local devices in accordance with an IEEE 802.11 protocol, although the invention is not so limited.

As also shown in FIG. 9, wireless networking device 806 also includes a WAN interface 914 that is configured for connection to and communication with a WAN, such as the Internet. Depending on the type of physical connection used for communication the WAN, WAN interface 914 may comprise, for example, an Ethernet port, a cable modem or a DSL modem. These examples are not intended to be limiting, however, and other WAN interface types may be used.

Wireless networking device 806 further includes WLAN interface control logic 904. WLAN interface control logic 904 is configured to route network layer packets received from wireless local devices connected to WLAN interface 902 to WAN interface 914 for subsequent delivery to entities on the WAN. In performing this function, WLAN interface control logic 904 is configured to first determine whether a network layer packet has been generated by an IPv4-capable device or an IPv6-capable device. If the network layer packet has been generated by an IPv4-capable device, then WLAN interface control logic 904 passes the network layer packet to IPv4 NAT logic 906 and firewall logic 908 so that NAT and firewall functions may be respectively performed on the packet prior to receipt by WAN interface 914. However, if the network layer packet has been generated by an IPv6-capable device and the network layer packet is formatted in accordance with IPv6, then WLAN interface control logic 904 passes the network layer packet directly to WAN interface 914 via bypass path 910.

To determine whether a network layer packet has been generated by an IPv4-capable device or an IPv6-capable device, WLAN interface control logic 904 is configured to access a table 918 that is stored in a local memory 916 within wireless networking device 806. In one embodiment, table 918 stores a list of unique IDs of all local IPv6-capable devices currently connected to network device 806. These unique IDs may be, for example, Ethernet addresses associated with each of the local IPv6-capable devices. In accordance with such an embodiment, WLAN interface control logic 904 is configured to obtain a unique ID from the header of an Ethernet frame that carries a network layer packet received from a wireless local device and then determines if the obtained unique ID matches any of the unique IDs stored in table 318. If a match is found, then the network layer packet is deemed to have come from an IPv6-capable device. However, if no match is found, then the network layer packet is deemed to have come from an IPv4-capable device.

Wireless networking device 806 further includes WAN interface control logic 912. WAN interface control logic 912 is configured to route network layer packets received from the WAN to WLAN interface 902 for subsequent delivery to the wireless local devices. In performing this function, WAN interface control logic 912 is configured to first determine whether a network layer packet is destined for an IPv4-capable device or an IPv6-capable device. If the network layer packet is destined for an IPv4-capable device, then WAN interface control logic 912 passes the network layer packet to IPv4 NAT logic 906 and firewall logic 908 so that NAT and firewall functions may be respectively performed on the packet prior to delivery to WLAN interface 902. However, if the network layer packet is destined for an IPv6-capable device and the network layer packet is formatted in accordance with IPv6, then WAN interface control logic 912 passes the network layer packet directly to WAN interface 902 via bypass path 910.

To determine whether a network layer packet is destined for an IPv4-capable device or an IPv6-capable device, WAN interface control logic 912 is configured to access table 918 stored in memory 916 in a like manner to that described above in reference to the operation of WLAN interface control logic 904. In particular, WAN interface control logic 912 is configured to obtain a unique ID from the header of an Ethernet frame that carries a network layer packet received from the WAN and then determines if the obtained unique ID matches any of the unique IDs stored in table 918. If a match is found, then the network layer packet is deemed to be destined for an IPv6-capable device. However, if no match is found, then the network layer packet is deemed to be destined for an IPv4-capable device.

In addition to performing functions described above, WLAN I/F control logic 904 may be configured to perform certain link layer services with respect to the wireless local devices connected to WLAN interface 902. These link layer services may include, for example, performing authentication of each of the wireless local devices and performing encryption and decryption of packets transmitted to and received from each wireless local device, respectively. These link layer services may be performed for each wireless local device regardless of whether that device is recognized as a wireless IPv4-capable device or a wireless IPv6-capable device by wireless networking device 806. This advantageously allows wireless IPv6-capable devices to avail themselves of these important link layer services, while bypassing the IP layer services such as NAT and firewall services into the WAN.

As described above, networking device 206 of FIG. 2 includes a plurality of LAN interfaces 212 for accommodating wired connections to a plurality of local devices and wireless networking device 806 of FIG. 8 includes a WLAN interface 812 for accommodating wireless connections to a plurality of wireless local devices. However, persons skilled in the relevant art(s) will readily appreciate that a networking device in accordance with an embodiment of the present invention may include both LAN and WLAN interfaces for accommodating both wired and wireless connections to local devices. Such an embodiment may perform selective bypassing of NAT and firewall functionality based on network layer protocol as described above for both the wired and wireless local devices. The manner in which such an embodiment would be implemented will be understood to persons skilled in the relevant art(s) based on the teachings provided herein.

G. Example Software-Based Implementation in Accordance with an Embodiment of the Present Invention

Various elements of a networking device in accordance with an embodiment of the present invention may be implemented in software, hardware, or as a combination of software or hardware. For example, with reference to the embodiment of networking device 206 depicted in FIG. 3, each of LAN interface control logic 304, WAN interface control logic 312, IPv4 NAT logic 306 and firewall logic 308 may be implemented in software, hardware, or as a combination of software or hardware. Similarly, with reference to the embodiment of wireless networking device 806 depicted in FIG. 9, WLAN interface control logic 904, WAN interface control logic 912, IPv4 NAT logic 906 and firewall logic 908 may be implemented in software, hardware, or as a combination of software and hardware.

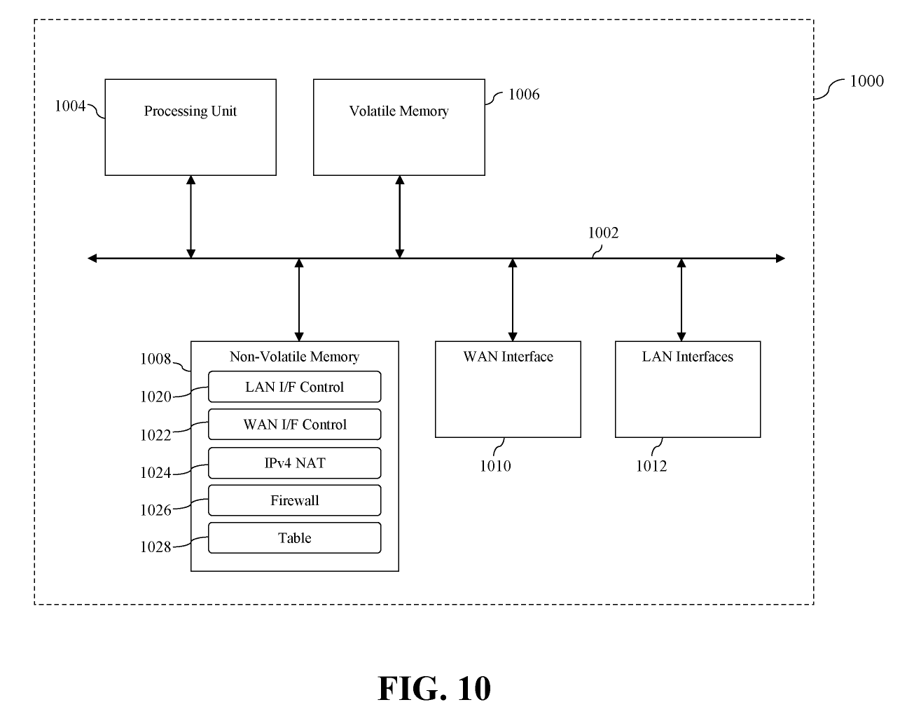

By way of example, FIG. 10 is a block diagram of a networking device 1000 in accordance with an embodiment of the present invention in which several elements are implemented in software configured for execution by a processing unit. Networking device 1000 may represent one implementation of networking device 206 of FIG. 3.

As shown in FIG. 10, networking device 1000 includes a number of components including a processing unit 1004, a volatile memory 1006, a non-volatile memory 1008, a WAN interface 1010, and LAN interfaces 1012. Each of these components is communicatively connected to the other via a communication infrastructure 1002, which may comprise a bus or a number of interconnected busses depending upon the implementation.

Processing unit 1004 is configured to execute software instructions, also referred to herein as computer program instructions or computer program logic. In particular, processing unit 1004 is configured to execute software instructions that are loaded from non-volatile memory 1008 into volatile memory 1006 at system start-up. Processing unit 1004 may comprise one or more general-purpose or special-purpose processors. A processor within processing unit 1004 may also include multiple processing cores.

Non-volatile memory 1008 is a memory that is used to persistently store information within networking device 1008 even when networking device 1000 is not powered. In one embodiment, non-volatile memory 1008 comprises a flash memory, although the invention is not so limited. Persons skilled in the relevant art(s) will readily appreciate that other non-volatile memory types may be used to implement this component.

Volatile memory 1006 is a memory that is used to store software instructions to be executed by processing unit 1004 as well as certain data used or generated by processing unit 1004 during execution of those software instructions. In one embodiment, volatile memory 1006 comprises a random access memory (RAM) although the invention is not so limited. Persons skilled in the relevant art(s) will readily appreciate that other volatile memory types may be used to implement this component.

As shown in FIG. 10, non-volatile memory 1008 stores various computer program logic elements including LAN interface control logic 1020, WAN interface control logic 1022, IPv4 NAT logic 1024, and firewall logic 1026. When networking device 1000 is powered on, these computer program logic elements are loaded from non-volatile memory 1008 to volatile memory 1006 for subsequent execution by processing unit 1004. During execution, each of these computer program logic elements perform the same functions as like-named elements of the embodiment of networking device 206 depicted in FIG. 3. As also shown in FIG. 10, a table 1028, which is analogous to table 318 of FIG. 3, may be stored in non-volatile memory 1008 as well.

As used herein, the terms “computer program medium” and “computer readable medium” are used to generally refer to any media that is capable of storing computer program logic (such as any of the computer program logic elements stored in non-volatile memory 1008) and of being read by a computer. For example, computer program medium and computer useable medium can refer to memories, such as volatile memory 1006 and non-volatile memory 1008. As used herein, the term “computer program product” is used to refer to software stored on any computer readable medium.

### H. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for routing network traffic between a plurality of local devices and a wide area network (WAN), comprising:
receiving an outgoing network layer packet destined for the WAN from one of the plurality of local devices;
determining if the outgoing network layer packet is associated with a local device that is configured for network communication in accordance with a first network layer protocol or a local device that is configured for network communication in accordance with a second network layer protocol;
performing a network address translation function on the outgoing network layer packet prior to transmitting the outgoing network layer packet to the WAN responsive to determining that the outgoing network layer packet is associated with a local device that is configured for network communication in accordance with the first network layer protocol; and
by passing the network address translation function and transmitting the outgoing network layer packet directly to the WAN responsive to at least determining that the outgoing network layer packet is associated with a local device that is configured for network communication in accordance with the second network layer protocol.

2. The method of claim 1, wherein the first network layer protocol is Internet Protocol version 4 (IPv4) and the second network layer protocol is Internet Protocol version 6 (IPv6).

3. The method of claim 1, wherein the step of bypassing the network address translation function and transmitting the outgoing network layer packet directly to the WAN is also performed responsive to determining that the outgoing network layer packet is formatted in accordance with the second network layer protocol.

4. The method of claim 1, further comprising:
performing a firewall function on the outgoing network layer packet prior to transmitting the outgoing network layer packet to the WAN responsive to determining that the outgoing network layer packet is associated with a local device that is configured for communication in accordance with the first network layer protocol; and
bypassing the firewall function and transmitting the outgoing network layer packet directly to the WAN responsive to at least determining that the outgoing network layer packet is associated with a local device that is configured for communication in accordance with the second network layer protocol.

5. The method of claim 1, wherein determining if the outgoing network layer packet is associated with a local device that is configured for network communication in accordance with a first network layer protocol or a local device that is configured for network communication in accordance with a second network layer protocol comprises:
obtaining a unique identifier from a header of an Ethernet frame that carries the outgoing network layer packet; and
determining if the obtained unique identifier matches any one of one or more unique identifiers stored in a local memory, wherein the stored unique identifiers are associated with local devices that are configured for network communication in accordance with the second network layer protocol.

6. The method of claim 5, further comprising:
receiving a link layer message from one of the plurality of local devices indicating that the one of the plurality of local devices is configured for network communication in accordance with the second network layer protocol; and
storing a unique identifier associated with the one of the plurality of local devices in the local memory responsive to receiving the link layer message.

7. The method of claim 5, further comprising:
analyzing one or more network layer packets received from one of the plurality of local devices to determine if the one of the plurality of local devices is configured for network communication in accordance with the second network layer protocol; and
storing a unique identifier associated with the one of the plurality of local devices in the local memory responsive to determining that the one of the plurality of local devices is configured for network communication in accordance with the second network layer protocol.

8. The method of claim 1, further comprising:
receiving an incoming network layer packet from the WAN;
determining if the incoming network layer packet is associated with a local device that is configured for network communication in accordance with the first network layer protocol or a local device that is configured for network communication in accordance with the second network layer protocol;
performing a network address translation function on the incoming network layer packet prior to transmitting the incoming network layer packet to one of the plurality of local devices responsive to determining that the incoming network layer packet is associated with a local device that is configured for network communication in accordance with the first network layer protocol; and
bypassing the network address translation function and transmitting the incoming network layer packet directly to one of the plurality of local devices responsive to at least determining that the incoming network layer packet is associated with a local device that is configured for network communication in accordance with the second network layer protocol.

9. The method of claim 8, wherein the step of bypassing the network address translation function and transmitting the incoming network layer packet directly to one of the plurality of local devices is also performed responsive to determining that the incoming network layer packet is formatted in accordance with the second network layer protocol.

10. The method of claim 8, further comprising:
performing a firewall function on the incoming network layer packet prior to transmitting the incoming network layer packet to one of the plurality of local devices responsive to determining that the incoming network layer packet is associated with a local device that is configured for network communication in accordance with the first network layer protocol; and
bypassing the firewall function and transmitting the incoming network layer packet directly to one of the plurality of local devices responsive to at least determining that the incoming network layer packet is associated with a local device that is configured for network communication in accordance with the second network layer protocol.

11. An apparatus, comprising:
a first interface configured for communication with a WAN;
a plurality of second interfaces, each of the plurality of second interfaces configured for communication with a corresponding one of a plurality of local devices;
network address translation (NAT) logic; and
first control logic coupled to the first interface, the plurality of second interfaces and the NAT logic, wherein the first control logic is configured to receive an outgoing network layer packet from one of the plurality of local devices via a corresponding second interface and to determine if the outgoing network layer packet is associated with a local device that is configured for network communication in accordance with a first network layer protocol or a local device that is configured for network communication in accordance with a second network layer protocol;
the first control logic being further configured to pass the outgoing network layer packet to the NAT logic prior to transmission of the outgoing network layer packet to the WAN via the first interface responsive to determining that the outgoing network layer packet is associated with a local device that is configured for communication in accordance with the first network layer protocol, and to bypass the NAT logic and transmit the outgoing network layer packet directly to the WAN via the first interface responsive to at least determining that the outgoing network layer packet is associated with a local device that is configured for communication in accordance with the second network layer protocol.

12. The apparatus of claim 11, wherein the first network layer protocol is Internet Protocol version 4 (IPv4) and the second network layer protocol is Internet Protocol version 6 (IPv6).

13. The apparatus of claim 11, wherein the first control logic is configured to bypass the NAT logic and transmit the outgoing network layer packet directly to the WAN via the first interface responsive also to determining that the outgoing network layer packet is formatted in accordance with the second network layer protocol.

14. The apparatus of claim 11, further comprising:
firewall logic;
wherein the first control logic is further configured to pass the outgoing network layer packet to the firewall logic prior to transmission of the outgoing network layer packet to the WAN via the first interface responsive to determining that the outgoing network layer packet is associated with a local device that is configured for communication in accordance with the first network layer protocol and to bypass the firewall logic and transmit the outgoing network layer packet directly to the WAN via the first interface responsive to at least determining that the outgoing network layer packet is associated with a local device that is configured for communication in accordance with the second network layer protocol.

15. The apparatus of claim 11, wherein the first control logic is configured to obtain a unique identifier from a header of an Ethernet frame that carries the outgoing network layer packet and to determine if the obtained unique identifier matches any one of one or more unique identifiers stored in a local memory, wherein the stored unique identifiers are associated with local devices that are configured for network communication in accordance with the second network layer protocol.

16. The apparatus of claim 15, wherein the first control logic is further configured to receive a link layer message from one of the plurality of local devices indicating that the one of the plurality of local devices is configured for network communication in accordance with the second network layer protocol and to store a unique identifier associated with the one of the plurality of local devices in the local memory responsive to receiving the link layer message.

17. The apparatus of claim 15, wherein the first control logic is further configured to analyze one or more network layer packets received from one of the plurality of local devices to determine if the one of the plurality of local devices is configured for network communication in accordance with the second network layer protocol and to store a unique identifier associated with the one of the plurality of local devices in the local memory responsive to determining that the one of the plurality of local devices is configured for network communication in accordance with the second network layer protocol.

18. The apparatus of claim 11, further comprising:
second control logic coupled to the first interface, the plurality of second interfaces and the NAT logic;
wherein the second control logic is configured to receive an incoming network layer packet from the WAN via the first interface, to determine if the incoming network layer packet is associated with a local device that is configured for network communication in accordance with the first network layer protocol or a local device that is configured for network communication in accordance with the second network layer protocol, to pass the incoming network layer packet to the NAT logic prior to transmission to one of the plurality of local devices via a corresponding second interface responsive to determining that the incoming network layer packet is associated with a local device that is configured for network communication in accordance with the first network layer protocol and to bypass the NAT logic and transmit the incoming network layer packet directly to one of the plurality of local devices via a corresponding second interface responsive to at least determining that the incoming network layer packet is associated with a local device that is configured for network communication in accordance with the second network layer protocol.

19. The apparatus of claim 18, wherein the second control logic is configured to bypass the NAT logic and transmit the incoming network layer packet directly to one of the plurality of local devices via a corresponding second interface responsive also to determining that the incoming network layer packet is formatted in accordance with the second network layer protocol.

20. The apparatus of claim 18, further comprising:
firewall logic;
wherein the second control logic is further configured to pass the incoming network layer packet to the firewall logic prior to transmission to one of the plurality of local devices via a corresponding second interface responsive to determining that the incoming network layer packet is associated with a local device that is configured for network communication in accordance with the first network layer protocol and to bypass the firewall logic and to transmit the incoming network layer packet directly to one of the plurality of local devices via a corresponding second interface responsive to at least determining that the incoming network layer packet is associated with a local device that is configured for network communication in accordance with the second network layer protocol.

21. A computer program product comprising a computer-readable medium having computer program logic recorded thereon for enabling a processing unit to route network traffic between a plurality of local devices and a wide area network (WAN), the computer program logic comprising:
first means for enabling the processing unit to receive an outgoing network layer packet destined for the WAN from one of the plurality of local devices;
second means for enabling the processing unit to determine if the outgoing network layer packet is associated with a local device that is configured for network communication in accordance with a first network layer protocol or a local device that is configured for network communication in accordance with a second network layer protocol;
third means for enabling the processing unit to perform a network address translation function on the outgoing network layer packet prior to transmitting the outgoing network layer packet to the WAN responsive to a determination that the outgoing network layer packet is associated with a local device that is configured for communication in accordance with the first network layer protocol; and
fourth means for enabling the processing unit to bypass the network address translation function and transmit the outgoing network layer packet directly to the WAN responsive to at least a determination that the outgoing network layer packet is associated with a local device that is configured for communication in accordance with the second network layer protocol.

22. The computer program product of claim 21, wherein the first network layer protocol is Internet Protocol version 4 (IPv4) and the second network layer protocol is Internet Protocol version 6 (IPv6).

23. The computer program product of claim 21, wherein the fourth means comprises means for enabling the processing unit to bypass the network address translation function and transmit the outgoing network layer packet directly to the WAN responsive to a determination that the outgoing network layer packet is associated with a local device that is configured for communication in accordance with the second network layer protocol and to a determination that that the outgoing network layer packet is formatted in accordance with the second network layer protocol.

24. The computer program product of claim 21, wherein the computer program logic further includes:
means for enabling the processing unit to perform a firewall function on the outgoing network layer packet prior to transmitting the outgoing network layer packet to the WAN responsive to a determination that the outgoing network layer packet is associated with a local device that is configured for communication in accordance with the first network layer protocol; and
means for enabling the processing unit to bypass the firewall function and transmit the outgoing network layer packet directly to the WAN responsive to at least a determination that the outgoing network layer packet is associated with a local device that is configured for communication in accordance with the second network layer protocol.

25. The computer program product of claim 21, wherein the second means comprises:
means for enabling the processing unit to obtain a unique identifier from a header of an Ethernet frame that carries the outgoing network layer packet; and
means for enabling the processing unit to determine if the obtained unique identifier matches any one of one or more unique identifiers stored in local memory, wherein the stored unique identifiers are associated with local devices that are configured for network communication in accordance with the second network layer protocol.

26. The computer program product of claim 25, wherein the computer program logic further comprises:
means for enabling the processing unit to receive a link layer message from one of the plurality of local devices indicating that the one of the plurality of local devices is configured for network communication in accordance with the second network layer protocol; and
means for enabling the processing unit to store a unique identifier associated with the one of the plurality of local devices in the local memory responsive to receiving the link layer message.

27. The computer program product of claim 25, wherein the computer program logic further comprises:
means for enabling the processing unit to analyze one or more network layer packets received from one of the plurality of local devices to determine if the one of the plurality of local devices is configured for network communication in accordance with the second network layer protocol; and
means for enabling the processing unit to store a unique identifier associated with the one of the plurality of local devices in the local memory responsive to determining that the one of the plurality of local devices is configured for network communication in accordance with the second network layer protocol.

28. The computer program product of claim 21, wherein the computer program logic further comprises:
fifth means for enabling the processing unit to receive an incoming network layer packet from the WAN;
sixth means for enabling the processing unit to determine if the incoming network layer packet is associated with a local device that is configured for network communication in accordance with the first network layer protocol or a local device that is configured for network communication in accordance with the second network layer protocol;
seventh means for enabling the processing unit to perform a network address translation function on the incoming network layer packet prior to transmitting the incoming network layer packet to one of the plurality of local devices responsive to a determination that that the incoming network layer packet is associated with a local device that is configured for network communication in accordance with the first network layer protocol; and
eighth means for enabling the processing unit to bypass the network address translation function and transmit the incoming network layer packet directly to one of the plurality of local devices responsive to at least a determination that the incoming network layer packet is associated with a local device that is configured for network communication in accordance with the second network layer protocol.

29. The computer program product of claim 28, wherein the eighth means comprises means for enabling the processing unit to bypass the network address translation function and transmit the incoming network layer packet directly to one of the plurality of local devices responsive to a determination that the incoming network layer packet is associated with a local device that is configured for network communication in accordance with the second network layer protocol and to a determination that that the outgoing network layer packet is formatted in accordance with the second network layer protocol.

30. The computer program product of claim 28, wherein the computer program logic further comprises:
means for enabling the processing unit to perform a firewall function on the incoming network layer packet prior to transmitting the incoming network layer packet to one of the plurality of local devices responsive to a determination that the incoming network layer packet is associated with a local device that is configured for network communication in accordance with the first network layer protocol; and
means for enabling the processing unit to bypass the firewall function and transmit the incoming network layer packet directly to one of the plurality of local devices responsive to at least a determination that the incoming network layer packet is associated with a local device that is configured for network communication in accordance with the second network layer protocol.

31. An apparatus, comprising:
a wired interface configured for communication with a WAN;
a wireless interface configured for communication with a plurality of local devices;
network address translation (NAT) logic; and
first control logic coupled to the wired interface, the wireless interface and the NAT logic, wherein the first control logic is configured to receive an outgoing network layer packet from one of the plurality of local devices via the wireless interface and to determine if the outgoing network layer packet is associated with a local device that is configured for network communication in accordance with a first network layer protocol or a local device that is configured for network communication in accordance with a second network layer protocol;
the first control logic being further configured to pass the outgoing network layer packet to the NAT logic prior to transmission of the outgoing network layer packet to the WAN via the wired interface responsive to determining that the outgoing network layer packet is associated with a local device that is configured for communication in accordance with the first network layer protocol, and to bypass the NAT logic and transmit the outgoing network layer packet directly to the WAN via the wired interface responsive to at least determining that the outgoing network layer packet is associated with a local device that is configured for communication in accordance with the second network layer protocol.

32. The apparatus of claim 25, further comprising:
second control logic coupled to the wired interface, the wireless interface and the NAT logic, the second control logic configured to receive an incoming network layer packet from the WAN via the wired interface, to determine if the incoming network layer packet is associated with a local device that is configured for network communication in accordance with the first network layer protocol or a local device that is configured for network communication in accordance with the second network layer protocol, to pass the incoming network layer packet to the NAT logic prior to transmission to one of the plurality of local devices via the wireless interface responsive to determining that the incoming network layer packet is associated with a local device that is configured for network communication in accordance with the first network layer protocol and to bypass the NAT logic and transmit the incoming network layer packet directly to one of the plurality of local devices via the wireless interface responsive to at least determining that the incoming network layer packet is associated with a local device that is configured for network communication in accordance with the second network layer protocol.
